(19) United States
(12) Patent Application Publication
(10) Pub. No.: US 2009/0214741 A1
(43) Pub. Date: Aug. 27, 2009

(54) LOW DENSITY STABLE WHIPPED FROSTING

(76) Inventors: Chandrani Atapattu, Maple Grove, MN (US); Kimberly A. Korb, Edina, MN (US); Brandon C. Erickson, Minneapolis, MN (US); Timothy W. Wylie, Blaine, MN (US); David K. Duffy, Maple Grove, MN (US); Lara A. Gilbert, Maple Grove, MN (US)

Correspondence Address: CALFEE HALTER & GRISWOLD, LLP, 800 SUPERIOR AVENUE, SUITE 1400, CLEVELAND, OH, 44114, US

(21) Appl. No.: 12/369,097

(22) Filed: Feb. 11, 2009

Related U.S. Application Data
(62) Division of application No. 10/986,623, filed on Nov. 12, 2004, now abandoned.
(60) Provisional application No. 60/519,185, filed on Nov. 12, 2003.

(51) Int. Cl. A23G 3/52

(52) U.S. Cl. 426/572

(57) ABSTRACT

The present invention includes a stable low density frosting composition having a density that ranges from about 0.65 grams per mL to about 0.95 grams per mL that contains a sweetening component, a plastic shortening component, an emulsifier component, a stabilizer component, and a liquid component. The present invention further includes a method of making the low density frosting by homogeneously blending each component to form a homogeneous frosting slurry followed by aerating to form the low density frosting composition.

### CROSS-REFERENCE TO RELATED APPLICATION(S)

The present application claims priority from Application Ser. No. 60/519,185 filed on Nov. 12, 2003 entitled “LOW DENSITY STABLE WHIPPED FROSTING by Chandrani Atapattu, Kimberly A. Korb, Brandon C. Erickson, Timothy W. Wylie, and Dave Duffy.

### BACKGROUND OF THE INVENTION

The present invention generally relates to ready-to-spread (RTS) frosting compositions. More specifically, the present invention relates to a stable low density ready-to-spread whipped frosting composition and to methods of making the stable low density ready-to-spread whipped frosting composition.

Frostings include a wide variety of spreadable, semi-solid confectionery products that are used as toppings to sweeten and decorate baked goods like cakes, breads, cookies, donuts, muffins, and the like. A ready-to-spread (RTS) frosting is a type of frosting that contains a shortening component, is aerated, and is designed to remain spreadable after an extended storage period at room temperature. As an example, RTS frostings may be stored unopened at room temperature for periods of up to about one year, or stored after opening at refrigerator temperatures for shorter periods.

RTS frostings are preferred by both consumers and commercial bakers alike since RTS frostings are convenient to use and reduce the time and resources required to produce a frosting product. RTS frostings are simply stirred and applied directly from the container to a cake without requiring any other preparation steps like the inclusion of other ingredients.

RTS frostings are generally prepared by introduction of gas cells through aeration or whipping that creates a foam. Preferably, RTS frostings possess a smooth texture, have a short consistency, remain spreadable without changes to the texture, are resistant to syneresis or weeping when present in an unopened container or between cake layers, are resistant to air cell collapse or coalescence during storage, and are able to retain a consistent texture after an extended storage period.

RTS frostings can generally be categorized into several types, depending in part on the type of foam created in the frosting, as measured by a density of the frosting. Traditional or conventional frostings typically have a density that ranges from about 1.00 to about 1.30 grams per milliliter (g per mL). Similarly, low density frostings have densities that are about 0.60 g per mL to about 0.95 g per mL. Very low density frostings have densities that are less than about 0.60 g per mL.

Furthermore, conventional frostings having a density of more than about 1 g per mL are generally characterized as creamy, rich, thick, heavy, and viscous. On the other hand, low density frostings with a density of about 0.65 g per mL to about 0.95 g per mL are typically characterized as fluffy, light, airy, glossy, smoother, less sticky, and easier to spread than conventional frostings. As a result, demand for low density frostings has increased in recent years.

Unfortunately, low density and very low density frostings are unstable and therefore, intended for immediate consumption. By “unstable” is meant that the volume of the frosting decreases upon application of a mechanical force, such as scooping, stirring, spreading or even after an extended storage period. Furthermore, the term “unstable” encompasses coalescence of gas cells present in the frosting after an extended storage period to give rise to large voids or air pockets that result in a heterogeneous texture and a variable density throughout the frosting. Other problems that may occur in low density or very low density frostings include phase separation of the oil phase from the aqueous phase of the frosting composition, and sugar crystal growth that results in an undesirable grainy texture.

In the past, various attempts to produce low density frostings that are stable upon extended storage have been met with additional complications. For example, some low density frosting compositions include a palm oil hardstock as part of the shortening component to help prevent collapse of the three-dimensional matrix that holds the gas cells. Although the palm oil hardstock permits extended storage periods, the palm oil hardstock gives rise to a waxy mouth feel during consumption in a manner that lowers consumer acceptability of the product.

Additionally, gels have been used to make low density frostings having a stiffer foam structure to minimize phase separation. Unfortunately, increased coalescence of air cells, and ultimately changes to the volume are also observed in low density frostings prepared with gels that do not form the correct interaction between the gel and emulsifying component in low density frostings. Increasing the stiffness of low density frostings also creates a product that may not be spreadable over bakery items, such as cakes. A continuing need exists for low density RTS whipped frostings that can maintain their desirable properties over extended periods.

### BRIEF SUMMARY OF THE INVENTION

The present invention includes a stable low density frosting composition having a density that ranges from about 0.65 grams per mL to about 0.95 grams per mL that contains a sweetening component, a plastic shortening component, a liquid component, and a stabilizing-emulsifying mixture that is effective to reduce air cell coalescence and phase separation. The present invention further includes a method of making the low density frosting by homogeneously blending each component to form a homogeneous frosting slurry followed by aerating to form the low density frosting composition.

### BRIEF DESCRIPTION OF THE DRAWINGS

FIG. 1 is a schematic of a process for producing a stable low density frosting composition in accordance with the present invention.

FIG. 2 is a schematic of an alternate process for producing a stable low density frosting composition in accordance with the present invention.

FIG. 3 is a schematic of an alternate process for producing a stable low density frosting composition in accordance with the present invention.

### DETAILED DESCRIPTION

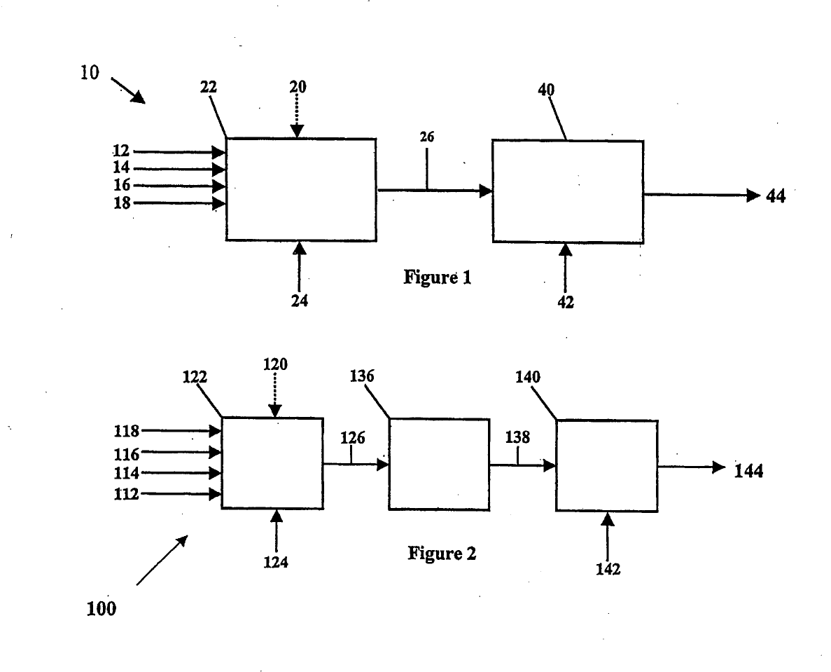

A process for producing a stable, low density, whipped frosting in accordance with the present invention is generally depicted at 10 in FIG. 1. In the process 10, a liquid component 12, a sweetening component 14, an emulsifying component 16, a stabilizing component 18, and any optional additives 20 are thoroughly mixed in a mixing apparatus 22 with heating to form an aqueous sugar composition. The aqueous sugar composition is typically continuously mixed until the sweetening component 14 reaches maximum solubility.

After mixing, a shortening component 24 that has been melted to remove all traces of fat crystalline material is added to the aqueous sugar composition. The shortening component 24 and the aqueous sugar composition are mixed until a smooth frosting slurry 26 is formed.

The smooth frosting slurry 26 is then transported into an aerating apparatus 40 where an inert gas 42 is added to the smooth frosting slurry 26. After adding the inert gas 42, the frosting slurry 26 is whipped in the aerating apparatus 40 with cooling to form a low density whipped frosting composition 44 having a density of about 0.65 grams per mL (g per mL) to about 0.95 g per mL. After whipping, the whipped frosting composition 44 is transferred from the aerating apparatus 40 into a packaging apparatus that packages the whipped frosting composition 44 and forms a packaged frosting composition.

The stability of a whipped frosting is due to a combination of factors. Stable whipped frosting must not undergo phase separation, must contain uniform air (gas) bubbles and air cells with a narrow size distribution, not undergo sugar crystal growth, remain spreadable, maintain a consistent density over extended time periods, and not undergo air cell coalescence.

Surprisingly, it has been discovered that including a unique combination of stabilizers and emulsifiers into a frosting composition in accordance with the present invention followed by aeration produces a ready-to-spread (RTS) low density frosting composition that is stable for an extended period of time. The low density frosting of the present invention has a (1) stable emulsion and aerated (foam) structure, (2) is capable of withstanding thermal abuse, (3) undergoes little, if any changes in density over a period of time, (4) has a narrow air cell size distribution and small air cells that minimizes coalescence, and (5) does not undergo phase separation or sugar crystal growth. As a result, the low density frosting of the present invention can be stored unopened for extended periods at room temperature with minimal changes to the volume, minimal separation of the aqueous and shortening phases, and minimal sugar crystal growth.

When preparing low density frostings, entrapment, retention and stabilization of air (gas) cells is important if the low density frosting is to remain stable for an extended period of time, such as more than about one month. As a result, low density frostings typically include a three dimensional matrix that entraps, retains and prevents coalescence of air (gas) cells. Unfortunately, the three dimensional matrix is generally insufficient in eliminating air coalescence after an extended time period. Consequently, additional stabilization of air (gas) cells is required in order to maximize stability of low density frostings.

While not wanting to be bound to theory, it is believed that preparing the low density whipped frosting containing a unique combination of stabilizing agent(s) and emulsifying agent(s) in accordance with the present invention permits formation of a three-dimensional matrix into which air cells are introduced and stabilized that allows the whipped frosting to maintain a consistent density of about 0.65 g per mL to about 0.95 g per mL over an extended time period. The stabilizing agent(s) of the present invention contain a thickening agent that increases the viscosity of the low density frosting and reduces moisture migration, sugar crystal growth and air cell coalescence by minimizing moisture and air cell migration.

Furthermore, the stabilizing agent(s) contain at least one gelling agent that is capable of forming a gel or a three-dimensional matrix that entraps and retains air cells in a stable foam structure. As used herein, a gel occurs when a polymeric chain of a gum, hydrocolloid or polysaccharide cross-links to form a contiguous three-dimensional molecular network in a liquid system. The three-dimensional network is believed capable of entrapping air, water, or any other liquid component to form a firm, flow-resistant structure. As a result, the combination of a thickener and gel in the present invention creates an internal structure that minimizes air cell migration, and therefore, air cell coalescence in the low density frosting.

Finally, the low density frosting of the present invention includes emulsifiers that contain at least one emulsifying agent that minimizes coalescence of air cells in the low density frosting of the present invention. While not wanting to be bound to theory, it is believed that the emulsifying agent(s) of the present invention are capable of (1) forming a thin film around air cells, (2) coating a surface of air cells, and/or (3) strengthening the existing thin film surrounding air cells so that air cells repel each other and prevent air cell coalescence. Therefore, the inclusion of appropriate levels of emulsifiers in the present invention creates an internal barrier around air cells that eliminates most if not all air cell coalescence in the low density frosting.

As a result, the stable foam is resistant to air cell collapse and/or coalescence upon storage for extended periods and minimal changes to the volume or density, and even separation of the aqueous and shortening phases do not occur. In addition, the stabilizer-emulsifier mixture minimizes sugar crystal growth in the low density frosting.

As used herein, the term “ready-to-spread” or “RTS” means minimal stirring is needed before using the frosting product. Furthermore, the term “low density”, as used herein, refers to a frosting composition having a density that ranges from about 0.65 g per mL to about 0.95 g per mL. Additionally, the term “frosting” in the present invention refers to a product that can be applied as a topping or filling to sweeten and decorate baked goods, such as for example, cakes, breads, donuts, muffins and cookies. Finally, as used herein, the term “stable” refers to a frosting product that undergoes minimal, if any, (1) separation of the aqueous phase from the oil phase, (2) volume or density changes, and/or (3) sugar crystallization after storage at room temperature for at least six months, and preferably for at least 12 months.

The terms “low density” and “whipped” are used interchangeably throughout the patent application. An example of ranges of components that is used to prepare the RTS low density whipped frosting of the present invention is presented in Table 1.

| Component | Concentration (percent by weight)* |
|---|---|
| Liquid component | about 10.00 to about 25.00 |
| Sweetening component | about 35.00 to about 76.00 |
| Emulsifying component | about 0.30 to about 1.35 |
| Stabilizing component | about 0.15 to about 1.20 |
| Plastic shortening component | about 12.00 to about 30.00 |

*based on the total amount of the low density frosting composition 44

The low density frosting composition 44 of the present invention generally includes the liquid component 12. The liquid component 12 may be supplied by any liquid component associated with the sweetening component 14, such as any liquid present in corn syrup, molasses, honey, or the like. Alternatively, and preferably, the liquid component 12 is included as part of the frosting composition 44 in the form of liquid water. Conventional potable water, distilled water, or reverse-osmosis distilled water, that is substantially free of objectionable taste, colors, odors and of approved bacteriological quality may be used in the present invention. The liquid component 12 is a key component of the aqueous phase of the low density frosting composition 44.

The liquid component 12 may be included at an amount that is effective to (1) liquify, (2) solubulize, and/or (3) homogeneously disperse, blend or mix any of the components used to prepare the low density frosting composition 44. The concentration of the liquid component may range from about 10 weight percent to about 25 weight percent, based on the total weight of the low density frosting composition 44. When the concentration of the liquid component 12 is higher than about 25 weight percent, a low density frosting that is generally too runny or thin in consistency is produced. When the concentration of the liquid component 12 is less than about 10 weight percent, a low density frosting that is typically too thick or difficult to spread is produced.

As an example, when preparing a low density chocolate base frosting in accordance with the present invention, the liquid component 12 is preferably liquid water included at a concentration of about 15 weight percent to about 21 weight percent, based on the total weight of the low density chocolate base frosting. Similarly, when preparing a low density light base frosting that does not contain any cocoa-related ingredients, the liquid component 12 is preferably liquid water included at a concentration of about 12 weight percent to about 18 weight percent, based on the total weight of the low density light base frosting. As used herein, the term “light base frosting” refers to a frosting that does not generally include any chocolate, cocoa, or cocoa-related ingredients in the frosting.

The sweetening component 14 of the low density frosting composition 44 may be generally mixed to form the smooth frosting slurry 26 as a liquid, mist, or in granular form. Additionally, the sweetening component 14 may be supplied as individual sweetening agent(s), or supplied in various prepared mixtures of two or more sweetening agent(s).

The sweetening component 14 generally includes one or more sweetening agent(s), such as any nutritive carbohydrate sweetening agent in the form of an edible oligosaccharide having one, two, or more saccharide groups like sucrose, fructose, dextrose, maltose, glucose, lactose, galactose, sorbitol, cane sugar, beet sugar, corn syrup, corn syrup solids, brown sugar, maple sugar, maple syrup, honey, molasses, 6×, 10×, 12×, or 20× ground sugar, high maltose corn syrup, high fructose corn syrup, invert sugar, or any combination of any of these.

Alternatively, the sweetening agent(s) may include one or more nutritive carbohydrate sweetening agent in combination with (1) any non-nutritive carbohydrate-based sweetening agent, (1) any non-nutritive, non-carbohydrate based sweetening agent, or (3) any combination of one or more nutritive carbohydrate sweetening agents(s), any non-nutritive carbohydrate-based sweetening agent and any non-nutritive, non-carbohydrate based sweetening agent. Suitable examples of non-nutritive carbohydrate- or non-carbohydrate-based sweetening agent(s), include Splenda®, Nutrasweet®, saccharin, or the like.

Additionally, the sweetening component 14 that is used in accordance with the present invention is an amount that is effective in providing bulk and body and contributing to the sweetness, texture, consistency, viscosity, density and taste of the low density frosting composition 44. Furthermore, the amount of the sweetening component 14 may vary, depending upon the desired characteristics of the low density frosting composition 44. Consequently, the amount of the sweetening component 14 may be any amount that provides the necessary sweetness and body to the low density frosting composition 44.

As noted, the concentration of the sweetening component 14 may range from about 35 weight percent to about 76 weight percent, based on the total weight of the low density frosting composition 44. Preferably, the concentration of the sweetening component 14 ranges from about 42 weight percent to about 76 weight percent, based on the total weight of the low density frosting composition 44. When preparing a low density chocolate base frosting, the concentration of the sweetening component 14 preferably ranges from about 42 weight percent to about 71 weight percent, based on the total weight of the low density chocolate base frosting. Similarly, when preparing a low density light base frosting, the concentration of the sweetening component 14 preferably ranges from about 51 weight percent to about 76 weight percent, based on the total weight of the low density light base frosting.

Still more preferably, the sweetening component 14 includes a combination of high maltose corn syrup, crystalline fructose and 12× ground sugar when preparing the low density frosting composition 44 in accordance with the present invention. Most preferably, the sweetening component 14 includes about 48 weight percent to about 62 weight percent of 12× ground sugar, about 2 weight percent to about 11 weight percent high maltose corn syrup, and less than about 4 weight percent crystalline fructose when preparing a low density light base frosting. About 40 weight percent to about 52 weight percent 12× ground sugar, about 2 weight percent to about 12 weight percent high maltose corn syrup, and less than about 7 weight percent crystalline fructose is preferred when preparing a low density chocolate base frosting.

Sugar may be purchased in the desired granulation (particle size specification) or comminuted prior to addition when preparing the low density frosting composition 44. The preferred 12× granulated (ground) sugar that is included as part of the sweetening component 14 may be characterized as sugar that has been ground to pass through a 200 US mesh size. In addition, the 12× granulated sugar preferably does not include more than about 2 weight percent of sugar particles having a size of more than about 75 microns, based on the total weight of the preferred 12× ground sugar that is used in accordance with the present invention.

Granulated sugar is often combined with a small amount of a processing or free flow agent. As an example, wheat or corn starch may be used as a free flow agent that is included as part of the granulated sugar composition. Preferably, about 2 to about 4 weight percent corn starch, based on the total weight of the preferred 12× granulated sugar, is included as part of the preferred 12× granulated sugar when practicing the present invention.

As used herein, the term “emulsifying component” refers to any ingredient that prevents the separation of emulsions or two immiscible substances. The emulsifying component 16 of the present invention may include one or more emulsifying agent(s) that are capable of forming the smooth frosting slurry 26 and may be generally added as a liquid, plastic, or in granular form. The emulsifying component 16 may be supplied as individual emulsifying agent(s) or supplied in various prepared mixtures of two or more emulsifying agent(s) that are subsequently combined to form the emulsifying component 16.

The emulsifying component 16 may be (1) added directly to the aqueous sugar composition, (2) included as part of the shortening component 24, or (3) included as any combination of (1) or (2). Alternatively and/or additionally, the emulsifying component 16 may be pre-hydrated with a portion of the liquid component, such as a portion of water when preparing the low density frosting composition 44, or pre-blended with other dry ingredients.

The emulsifying agent(s) have a polar group with an affinity for water (hydrophilic) and a non-polar group which is attracted to oil (lipophilic). As a result, emulsifying agents possess both hydrophilic and lipophilic properties that are sometimes expressed in terms of a hydrophilic/lipophilic balance (HLB) value. Low HLB values indicate greater lipophilic tendencies in emulsifiers and are used to stabilize water-in-oil emulsions while high HLB values are assigned to hydrophillic emulsifiers and are typically used in oil-in-water emulsions.

Emulsifying agents may also be characterized as aerating emulsifying agents that assist in the aeration of food compositions. Suitable aerating emulsifying agents includes esters of polyhydric alcohols like sorbitan esters that include polyoxyethylene fatty acid esters of polyhydric alcohols like polyethoxylated esters of sorbitan, polyoxyethylene sorbitan monostearate, polyglycerol esters of higher fatty acids, polyoxy-20-ethylene sorbitan monooleate, polyoxy-20-ethylene sorbitan stearate (Polysorbate 60), and any combination of any of these. Aerating emulsifiers may also be characterized as hydrophilic emulsifiers.

Some other non-exhaustive examples of emulsifying agent(s) that may be used to practice the present invention include monoglycerides, diglycerides, propylene glycol monostearate, polypropylene esters of fatty acid, sodium stearoyl lactylate, lecithin, triglycerol monostearate, decaglycerol monooleate, decaglycerol monopalmitate, decaglycerol dipalmitate, hexaglycerol monostearate and any combination of any of these.

The emulsifying component 16 of the low density frosting composition 44 may be included at an amount that is effective to (1) provide a shorter texture, (2) provide a spreadable consistency, (3) provide body, (4) enhance aeration, and (5) provide a creamy mouth feel. Furthermore, the amount of the emulsifying component 16 may be varied, depending upon mixing, de-aerating, homogenizing, cooling and/or whipping conditions, the sweetening component 14, the stabilizing component 18, any optional additives 20, the shortening component 24, the liquid component 12, the inert gas 42, the desired degree of aeration, and the desired storage period.

It has been discovered that increasing amounts of emulsifying agent(s) have a negative effect on the stability of low density frostings as measured by the size (volume) and uniformity of air (gas) cells since increasing amounts of emulsifying agent(s) increase the size (volume) and non-uniformity of air cells. Emulsifying agent(s) are believed to function by reducing the surface tension of the aqueous phase present in the low density frosting, which enhances incorporation of more air (gas) cells into the low density frosting.

As used herein, the volume or size of air (gas) cells in a frosting sample is measured by preparing a microscopic slide of a thin film of frosting under a cover slip. At a magnification of 100×, a picture of bubbles (air cells) is taken and imported into imaging software, such as Optimas 6.5 imaging software (Media Cybernetics, Silver Spring, Md.). The imaging software then isolates the bubbles from the image and measures the diameter of the bubbles. After measuring the diameter, the data is imported into Microsoft® Excel software program (Microsoft Corporation, Redmond, Wash.) for statistical analysis. The average and standard deviation of the air cell size (bubble size) for the frosting sample is calculated and recorded.

Therefore, increasing amounts of emulsifying agent(s) can decrease the stability of low density frostings by permitting inclusion of larger sized air cells and air cells having a wider range of sizes (volumes) since there is a reduction in surface tension of the aqueous phase by the emulsifying agent(s). As a result, larger sized air cells and air cells having a wider range of sizes (volumes) are more easily introduced into the low density frosting, which promotes air cell coalescence and ultimately, changes to the volume and density in the low density frosting over an extended time period.

It has also been discovered that increasing amounts of emulsifying agent(s) have a positive effect on the stability of low density frostings as measured by a reduction in the degree to which changes in the density of low density frostings occurs after an extended period of time. As noted, emulsifying agent(s) are believed to coat the surface of air cells which helps air cells repel each other, and therefore, reduce air cell coalescence, and ultimately reduce changes to the density.

As used herein, the change in density for a low density frosting sample is measured by weighing a known volume of frosting, which is filled directly from a packaged low density frosting product that has been subjected to little, if any disturbance. The change in density is designed to measure the amount of gas leaving a sample of the low density frosting composition 44 after an extended time period.

Similarly, the stir density is designed to measure the amount of gas leaving the whipped frosting product due to normal consumer use, such as normal stirring. The stir density is measured by stirring a retail (consumer package containing about 12 ounces of whipped frosting) of the low density frosting 20 times followed by weighing a known volume of the low density frosting. Therefore, increasing the amount of emulsifying agents can increase the stability of low density frostings by decreasing the degree to which the density changes. As noted above, since it is believed that emulsifying agent(s) coat the surface of air (gas) cells, and aid in incorporation of air cells, emulsifying agent(s) can both increase and decrease the stability of low density frostings.

It has also been discovered that higher concentrations of emulsifying agents have no effect on a thermal stability of low density frostings. As used herein, the term “thermal stability” refers to a lack of visible separation of the aqueous, oil and/or solid phases in a sample of low density frosting after subjecting the sample to cycling temperature conditions. When testing the thermal stability of a frosting sample, a sample of low density frosting is placed into a test tube and subjected to temperature conditions that cycle from about 70° F. (room temperature) to about 130° F. 6 times (cycles) within a time span of about 18 minutes. Failure of the thermal stability test occurs when the frosting sample undergoes phase separation after completion of 6 cycling conditions. Therefore, higher concentrations of emulsifying agents in low density frosting do not have an effect on phase separation after completion of 6 cycling conditions.

As noted, the concentration of the emulsifying component 16 may range from about 0.30 weight percent to about 1.35 weight percent of the low density frosting composition 44 when practicing the present invention. When the emulsifying component 16 is less than about 0.30 weight percent, inadequate stabilization of air cells, and therefore, increased air cell coalescence occurs after an extended period. Similarly, if the emulsifying component 16 is more than about 1.35 weight percent, the amount and size of air cells incorporated into the low density frosting is too much, and consequently, increased air cell coalescence also occurs after an extended time period. Preferably, the concentration of the emulsifying component 16 ranges from about 0.50 weight percent to about 1.35 weight percent of the low density frosting composition 44 when practicing the present invention.

The emulsifying component 16 of the present invention preferably includes Texture Lite®, lecithin and Polysorbate 80. Texture Lite® is available from Quest International of Hoffman Estates, Ill., and is a blend of distilled monoglycerides, distilled propylene glycol and sodium stearoyl lactylate and is preferably included at a concentration of about 0.35 to about 0.80 weight percent, based on the total weight of the low density frosting composition 44. Preferably, lecithin and Polysorbate 80 are both included at a concentration of about 0.05 to about 0.10 weight percent, based on the total weight of the low density frosting composition 44.

Still more preferably, when preparing a low density chocolate base frosting in accordance with the present invention, the emulsifying component 16 includes TextureLite® at a concentration of about 0.35 weight percent to about 0.45 weight percent, and lecithin and Polysorbate 80 at concentrations of about 0.05 weight percent to about 0.10 weight percent, based on the total weight of the low density chocolate base frosting 44. Similarly, when preparing a low density light base frosting, the emulsifying component 16 includes Texture Lite® at a concentration of about 0.35 weight percent to about 0.45 weight percent, and lecithin and Polysorbate 80 at concentrations of about 0.05 weight percent to about 0.10 weight percent, based on the total weight of the low density light base frosting.

The stabilizing component 18 may be generally added to the aqueous sugar composition in a concentration that is effective to (1) provide a smooth consistent body and texture of the low density frosting composition 44, (2) form the three-dimensional matrix that entraps and retains gas cells, (3) prevent coalescence of air cells, (4) prevent fat crystal migration, and/or (5) reduce sugar crystal growth by reducing sugar molecule migration.

It has been discovered that increasing concentrations of stabilizing agent(s) have a negative effect on the stability of low density frostings as measured by the size (volume) and uniformity of air cells since increasing amounts of stabilizing agent(s) increase the volume and non-uniformity of air cells. Therefore, higher concentrations of stabilizing agent(s) can decrease the stability of low density frostings by permitting inclusion of larger sized air cells and air cells having a wider range of sizes (volumes).

It has also been discovered that increasing concentrations of stabilizing agent(s) have a negative effect on the stability of low density frostings as measured by an increase in changes to the density of the low density frosting over an extended time period. An increase in the stir density over an extended time period is also observed when higher concentrations of stabilizing agent(s) are included as part of the low density frosting composition 44. Therefore, increasing the concentrations of stabilizing agent(s) can decrease the stability of low density frostings over extended time periods.

Furthermore, it has been discovered that increasing concentrations of stabilizing agent(s) have a positive effect on a thermal stability of low density frostings. Therefore, higher concentrations of stabilizing agent(s) can increase the degree to which low density frostings do not undergo phase separation after completion of 6 cycling conditions.

While not wanting to be bound to theory, it is believed that the enhanced thermal stability observed in low density frostings prepared with higher concentrations of stabilizing agent(s) is due to formation of a gel or three-dimensional network that creates a stiff foam. The stiffer foam minimizes phase separation, and therefore enhances the stability of low density frostings.

In addition, a gel that is not properly dispersed and/or solubulized can increase the inclusion of larger sized air cells and air cells having a wider range of sizes (volumes) that results in air cell collapse and ultimately changes to the volume and density in the low density frosting over extended periods of time.

As noted, the stabilizing component functions as both a gel and a thickener when practicing the present invention. As used herein, a thickener is any ingredient added to a liquid component to increase the viscosity of the liquid component. Thickeners generally function by binding water and/or hydrating polymeric chains of a gun, hydrocolloid, or polysaccharide rather than entrapping the liquid or water component within a three dimensional gel network.

The stabilizing component 18 may include one or more stabilizing agent(s) and may be added in liquid or granular form. In addition, the stabilizing component 18 may be supplied as individual stabilizing agent(s) or supplied in various prepared mixtures of two or more stabilizing agents(s) that are subsequently combined to form the stabilizing component 18.

Some non-exhaustive examples of suitable stabilizing agent(s) that may be included as part of the stabilizing component 18 include any hydrocolloid, such as microcrystalline cellulose, sodium carboxymethylcellulose, carboxymethylcellulose, carrageenan gum, guar gum, locust bean gum, alginates, xanthan gum, agar-agar, gellan gum, gelatin, pectin, low-methoxyl pectin, or any other polymeric ingredient, such as whey protein isolate, whey protein concentrate, milk protein concentrate, milk protein isolate, whey, whey powder, whey protein, skim milk, nonfat dry milk, milk powder, casein, caseinates, milk protein, whey hydrolysate, buttermilk, whole milk, high fat milk powder, or any combination of any of these. Preferably, the stabilizing component 18 includes a combination of microcrystalline cellulose and sodium carboxymethylcellulose in the form of Cellulose Gel® (FMC Corporation of Philadelphia, Pa.) and carrageenan gum when practicing the present invention.

The amount of the stabilizing component 18 may vary depending upon the desired body, viscosity, density, spreadability, consistency, and texture of the low density frosting composition 44, particularly after storage for extended time periods. The concentration of the stabilizing component 18 typically ranges from about 0.15 weight percent to about 1.20 weight percent, based on the total weight of the low density frosting composition 44 when practicing the present invention.

Preferably, the stabilizing component 18 ranges from about 0.45 weight percent to about 0.70 weight percent, based on the total weight of the low density frosting composition 44. When the stabilizing component 18 is less than about 0.45 weight percent, then insufficient thickening and gel formation within the low density frosting is observed. When the stabilizing component 18 is more than about 0.70 weight percent, the foam structure is too stiff and the stability of the low density frosting is reduced.

Still more preferably, when preparing a low density light base frosting in accordance with the present invention, the stabilizing component 18 includes Cellulose Gel® at a concentration of about 0.30 weight percent to about 0.50 weight percent and carrageenan at a concentration of about 0.15 weight percent to about 0.25 weight percent, based on the total weight of the low density light base frosting. Similarly, when preparing a low density chocolate base frosting in accordance with the present invention, the stabilizing component 18 preferably includes Cellulose Gel® at a concentration of about 0.30 weight percent to about 0.40 weight percent and carrageenan at a concentration of about 0.15 to about 0.20 weight percent, based on the total weight of the low density chocolate base frosting.

As noted above, the emulsifying component 16 stabilizes individual air cells by enhancing repulsion which decreases air cell coalescence, while the stabilizing component 18 increases the viscosity of the liquid component and forms a three dimensional network that minimizes air cell migration. Therefore, the unique combination of the emulsifying component 16 and the stabilizing component 18 enable production of low density frosting compositions that do not undergo phase separations, volume changes, sugar crystal growth and density changes over extended time periods and varying temperature conditions.

Since the present invention includes the discovery that the type and concentration of stabilizing agent(s) and emulsifying agent(s) can be used to manipulate the stability of low density frostings, a unique stabilizer-emulsifier mixture having about 0.15 weight percent to about 1.20 weight percent stabilizing component 18 and about 0.30 weight percent to about 1.35 weight percent of the emulsifying component 16 has been found to stabilize low density frostings when practicing the present invention.

Optional additives 20 generally include color, colored bits, preservatives, metal chelators, non-fat dry milk, medium heat non-fat dry milk, high heat non-fat dry milk, low heat non-fat dry milk, one or more milk protein powder(s), flavors, such as vanilla, strawberry, raspberry, cherry, lemon, apricot, mocha, rum, amaretto, hazelnut, coffee, Irish creme, almond, caramel, sour cream, or the like, and a variety of materials that modify and preferably enhance the processing, nutritional, organoleptic and flavor properties of the low density whipped frosting composition 44. The concentration of the optional additives typically ranges from 0 to about 10 weight percent, based on the total weight of the low density frosting composition 44.

In addition, cocoa powder, chocolate, chocolate liquor, or any other cocoa containing ingredient may be included as part of the optional additives 20 when practicing the present invention. For example, up to about 6 weight percent chocolate liquor and about 1.5 weight percent to about 5.5 weight percent cocoa powder may be added to form a chocolate-flavored whipped frosting. Chocolate liquor typically contains about 53 weight percent cocoa butter and about 47 weight percent cocoa powder. However, cocoa butter, which has an iodine value of about 32 and a palmitic fatty acid content of less than about 26 weight percent, based on the total weight of the fatty acid content of the cocoa butter, is not believed capable of directing formation of fat crystals in the whipped frosting when practicing the present invention.

The plastic shortening component 24 may be generally included to form the smooth frosting slurry 26 as a liquid, solid, or in granular form. In addition, the plastic shortening component 24 may be supplied as individual shortening blend(s), or supplied in various prepared mixtures of two or more shortening blend(s) that are combined to form the plastic shortening component 24.

As used herein, the term “plastic” means a solid or semi-solid shortening, oil or fat blend at a room temperature of about 70° F. The plastic shortening component 24 may be derived from any partially-hydrogenated, non-hydrogenated, hydrogenated, fully hydrogenated, fractionated, interesterified fat or oil, or any combination of partially-hydrogenated, non-hydrogenated, hydrogenated, fractionated, interesterified fat or oil. The plastic shortening component 24 can have a melting point of between about 100° F. to about 130° F. and may be derived from soybean oil, cottonseed oil, peanut oil, coconut oil, corn oil, safflower oil, sunflower seed oil, canola oil, and any combination thereof.

Additionally, the plastic component 24 that is suitable for use in the present invention can have a Solids Fat Index (SFI) of about 28 percent at about 70° F. and about 13 percent at about 104° F. Alternatively, the plastic component 24 may have an SFI of about 28 percent at about 70° F. and about 7.5 percent at about 104° F.

The plastic shortening component 24 preferably does not include a palm oil hardstock. As used herein, a “palm oil hardstock” is a triglyceride mixture derived from palm oil having (1) a major portion of glycerol molecules that are bound to fatty acids that have only single carbon-carbon bonds, (2) a minor portion of glycerol molecules that are bound to fatty acids that contain carbon-carbon double bonds as defined by an iodine value of about 25 to about 45 and (3) greater than or equal to 40% of the fatty acids of the triglyceride mixture present in the form of fatty acids having 16 carbon atoms, based on the total fatty acids of the triglyceride mixture derived from palm oil.

Although the presence of enhanced levels of palmitic fatty acids is known to stabilize prior low density frostings, enhanced levels of palmitic fatty acids can also produce a waxy mouth feel in the low density frosting. Therefore, the plastic shortening component 24 preferably includes less than about 13% palmitic fatty acids, based on the total fatty acid content of the plastic shortening component 24. Still more preferably, the plastic shortening component 24 contains less than about 12.65% palmitic fatty acids, based on the total fatty acid content of the plastic shortening component 24. Most preferably, the plastic shortening component 24 has less than about 11.50% palmitic fatty acids, based on the total fatty acid content of the plastic shortening component 24.

A suitable plastic shortening component 24 is a partially hydrogenated oil having an iodine value of about 65 to about 85. As an example, the plastic shortening component 24 can include partially hydrogenated soybean oil, partially hydrogenated cottonseed oil, and any combination of these with an iodine value of about 72 to about 78, and a palmitic fatty acid content of less than about 13 weight percent, based on a total fatty acid content of the partially hydrogenated oil.

In another example, the plastic shortening component 24 may contain a blend of partially hydrogenated soybean and partially hydrogenated cottonseed oils that are derived from a blend of 95 weight percent partially hydrogenated soybean oil and 5 weight percent partially hydrogenated cottonseed oil in accordance with the present invention. In a third example, the plastic shortening component 24 may contain a blend of about 88 weight percent of partially hydrogenated or fractionated soybean oil and about 12 weight percent of cottonseed hardstock oil.

Additionally, a portion of the emulsifier component 16 may be pre-blended with the plastic shortening component 24 to form an emulsified shortening. The term “emulsified shortening” as used herein is meant to encompass the combination of the plastic shortening component, and apart or all of the emulsifier component 16 of the low density frosting composition 44. Therefore, the plastic shortening component can include up to about 3% of the emulsifier component. As an example, the plastic shortening component 24 may contain a blend of about 93 weight percent partially hydrogenated soybean oil, about 5 weight percent partially hydrogenated cottonseed oil, and about 2 weight percent distilled monoglycerides.

Additionally, the plastic shortening component 24 is an amount that is effective in providing bulk and body to the low density frosting composition 44 and contributing to the three-dimensional matrix that is used to entrap and retain gas cells. Furthermore, the amount of the plastic shortening component 24 may vary, depending upon the desired characteristics of the low density frosting composition 44. The plastic shortening component 24 generally ranges from about 12 weight percent to about 30 weight percent, based on the total weight of the low density frosting composition 44. Preferably, the plastic shortening 24 ranges from about 16 weight percent to about 21 weight percent when preparing a low density light base frosting or low density chocolate base frosting in accordance with the present invention.

The smooth frosting slurry 26 is formed after homogeneously mixing, dispersing, or blending each component of the frosting slurry 26 while heating in the mixing apparatus 20. As used herein, a “dispersed” component refers to any component that is distributed throughout the low density frosting composition, but is not dissolved in the low density frosting composition. In general, any suitable mixing apparatus that is effective to homogeneously disperse and/or mix each component of the frosting slurry 26 may be used in accordance with the present invention.

The smooth frosting slurry 26 may be mixed with heating until the slurry 26 reaches a temperature range of about 115° F. to about 150° F. As an example, the frosting slurry may be heated to a temperature range of about 140° F. to about 150° F. in order to maximize sugar solubilization when practicing the present invention. In a second embodiment, the frosting slurry may be mixed with concomitant heating until the slurry 26 is at a temperature range of about 115° F. to about 135° F., and preferably about 119° F. to about 131° F. when preparing the low density frosting composition 44. Additionally, the slurry 26 may be held at the elevated temperatures for at time that is effective to ensure that each component of the frosting slurry 26 is homogeneously dispersed, blended or mixed in the frosting slurry 26.

While the present invention generally discloses a preferred order of adding each component to form the smooth frosting slurry 26, it is to be understood that any desired order of addition of each component may be practiced when forming the smooth frosting slurry 26, so long as each component is homogeneously mixed, dispersed or blended to form the smooth frosting slurry 26. The density of the smooth frosting slurry 26 may range from about 1.00 g per mL to about 1.26 g per mL when practicing the present invention. Preferably, the density of the frosting slurry 26 ranges from about 1.00 g per mL to about 1.10 g per mL when preparing the low density frosting composition 44.

Furthermore, the term “homogeneously mixing, dispersing or blending”, as used herein, should not be confused with homogenization techniques commonly applied in the preparation of frostings. By homogenization is meant (1) dispersion of any fat molecules within the frosting slurry to effectively result in a greater dispersion of the fat molecules in the slurry through use of a homogenizer, and (2) reduction of the diameter of fat molecules. Indeed, it has been discovered that a homogenization step is optional and not required when practicing the present invention.

Next, the smooth frosting slurry can be transferred into the aerating apparatus 40 and injected with an inert gas 42 that aerates or reduces the density of the smooth frosting slurry 26 to form the low density frosting composition 44. Some non-exhaustive examples of non toxic, odorless, tasteless inert gases 42 that can be used in accordance with the present invention include air, nitrogen, nitrous oxide, carbon dioxide, and any combination of any of these. The inert gas 42 is typically injected into the smooth frosting slurry 26 when preparing the low density frosting composition 44.

The inert gas 42 is typically included at an amount that is effective to reduce the density of the smooth frosting slurry 26 to a density of about 0.65 g per mL to about 0.95 g per mL. Preferably, the density of the low density frosting composition 44 ranges from about 0.70 g per mL to about 0.90 g per mL after adding the inert gas 42. Still more preferably, the density of the low density frosting composition ranges from about 0.75 g per mL to about 0.80 g per mL. As an example, when the inert gas is nitrogen, about 65 mL to about 175 mL of nitrogen gas per pound of frosting slurry 26 may be added to attain a density of about 0.65 g per mL to about 0.95 g per mL when practicing the present invention. Preferably, about 90 mL to about 150 mL of nitrogen gas per pound of frosting slurry 38 is added to the smooth frosting slurry 26 to form the low density frosting composition 44 having a density of about 0.75 g per mL to about 0.88 g per mL.

After adding the inert gas 42, the frosting slurry 26 is sheared at about 100 to about 600 revolutions per minute (rpm) for a time that is effective to whip, aerate and/or incorporate the inert gas into the frosting slurry 26 and form the low density whipped frosting composition 44. As an example, the frosting slurry 26 may be sheared using a continuous aerator operating at a range of about 225 rpm to about 600 rpm for about 9 to about 18 seconds. The inert gas 42 and the frosting slurry 26 typically enter the mixing head simultaneously.

It has been discovered that whipping or shearing the frosting slurry 26 during aeration adds an effective amount of mechanical energy that enables attainment of a density of about 0.65 g per mL to about 0.95 g per mL in the low density frosting. The mechanical energy applied to the frosting slurry 26 is a function of a flow rate of the frosting slurry 26 into the aerating apparatus 40 and the RPM's.

Furthermore, if there is an insufficient amount of mechanical energy applied to the frosting slurry 26, then the inert gas is not effectively incorporated into the frosting slurry and a density of more than about 0.95 g per mL can occur. Similarly, if too much mechanical energy is applied to the frosting slurry 26, then a density of less than about 0.65 g per mL or the formation of an unstable foam results. Preferably, at least about 0.63 foot-pounds per pound of frosting slurry is applied to form a low density frosting of about 0.87 g per mL or less, when frosting slurry flow rate of about 4 pounds per minute is used.

In a second embodiment, the frosting slurry 26 may be whipped using two mixing heads operated in series at about 150 rpm to about 600 rpm for about 14 to about 16 seconds to form a low density frosting composition having a density of about 0.75 g per mL to about 0.81 g per mL. Aeration typically occurs with simultaneous cooling so that maximum gas incorporation is achieved. After aeration, the low density whipped frosting composition 44 is sent to a packaging system where the low density whipped frosting composition 44 is packaged into the appropriate packaging material.

An alternate process for producing a stable, low density, whipped frosting in accordance with the present invention is generally depicted at 100 in FIG. 2. In the process 100, a liquid component 112, a sweetening component 114, an emulsifying component 116, a stabilizing component 118, and any optional additives 120 are thoroughly mixed in a mixing apparatus 122 with heating to form an aqueous sugar composition. The aqueous sugar composition is typically continuously mixed until the sweetening component 114 reaches maximum solubility.

After mixing, a shortening component 124 that has been melted to remove all traces of fat crystalline material is added to the aqueous sugar composition. The shortening component 124 and the aqueous sugar composition are mixed until a smooth frosting slurry 126 is formed.

The smooth frosting slurry 126 is transferred from the mixing apparatus into a cooling apparatus 136 that cools the smooth frosting slurry 126 down to a temperature of about 70° F. to about 100° F. to form a cooled frosting slurry 138. After cooling, the cooled frosting slurry 138 is transferred from the cooling apparatus 136 and into an aerating apparatus 140 where an inert gas 142 is added to the cooled frosting slurry 138. After adding, the inert gas 142, the frosting composition is whipped in the aerating apparatus 140 with concomitant cooling to form a low density whipped frosting composition having a density of about 0.65 g per mL to about 0.95 g per mL. After whipping, the whipped frosting composition 144 is transferred from the aerating apparatus into a packaging apparatus that packages the whipped frosting composition 144 and forms a packaged frosting composition.

While not wanting to be bound to theory, it is believed that cooling enhances gas retention in the low density whipped frosting composition 144. Preferably, the frosting slurry 126 is cooled down to a temperature of about 75° F. to about 85° F., and most preferably to a temperature of about 77° F. to about 90° F. when preparing a low density light base frosting in accordance with the present invention. Similarly, the frosting slurry 126 is preferably cooled down to a temperature of about 80° F. to about 100° F., and most preferably to a temperature of about 85° F. to about 95° F. when preparing a low density chocolate base frosting in accordance with the present invention.

Cooling is generally accomplished by using one or more scraped surface heat exchanger(s). In general, any suitable scraped surface heat exchanger may be used to cool the smooth frosting slurry when practicing the present invention. As an example, the Votator II Scraped Surface Heat Exchanger that is available from Waukesha Cherry-Burrell of Delavan Wisconsin may be used as the cooling apparatus to cool the frosting slurry 126.

Total cooling times may range from about 80 seconds to about 7 minutes when cooling the frosting slurry 126 down to temperatures of about 70° F. to about 95° F. depending on the number and size of scraped surface heat exchangers that are used. The density of the frosting slurry 126 typically ranges from about 1.08 g per mL to about 1.29 g per mL during cooling of the smooth frosting slurry 126. Preferably, the density of the frosting slurry 126 ranges from about 1.15 g per mL to about 1.25 g per mL during the cooling step.

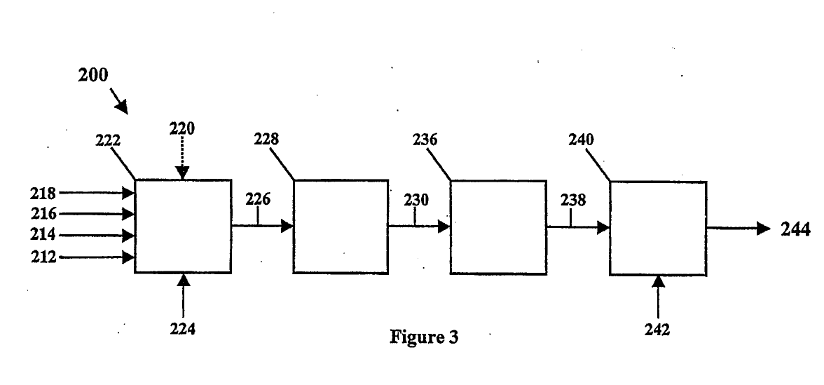

A third process for producing a stable low density frosting is generally depicted at 200 in FIG. 3. In the process 200, a liquid component 212, a sweetening component 214, an emulsifying component 216, a stabilizing component 218, and any optional additives 220 are thoroughly mixed in a mixing apparatus 222 with heating to form an aqueous sugar composition. The aqueous sugar composition is typically continuously mixed until the sweetening component 214 reaches maximum solubility.

After mixing, a shortening component 224 that has been melted to remove all traces of fat crystalline material is added to the aqueous sugar composition. The shortening component 224 and the aqueous sugar composition are mixed until a smooth frosting slurry 226 is formed.

The smooth frosting slurry 226 is transferred from the mixing apparatus into a vacuum apparatus 228 to remove any gases from the frosting slurry 226 and form a de-aerated frosting slurry 230. The vacuum apparatus is generally operated at conditions of about 20 inches mercury to about 25 inches mercury of vacuum pressure when practicing the present invention. The temperature of the smooth frosting slurry 226 generally ranges from about 110° F. to about 150° F. when de-aerating the frosting slurry 226.

As an example, the temperature of the frosting slurry 126 may range from about 140° F. to about 150° F. during de-aeration when elevated temperatures are used to ensure maximum dissolution of the sweetening component 214. Alternatively, the temperature of the frosting slurry 226 may range from about 110° F. to about 130° F. and preferably from about 114° F. to about 126° F. during aeration. After de-aeration, the de-aerated frosting slurry 230 has a density of about 1.15 g per mL to about 1.25 g per mL.

As noted above, a homogenization step is optional. However, should homogenization be included as part of the present invention, homogenization would typically occur after de-aeration. Homogenization is typically accomplished through the use of a homogenizer, such as a two-stage piston homogenizer that operates at two different pressures, such as at about 500 to about 1000 psi at the first stage and about 500 psi at the second stage.

Homogenization of the de-aerated frosting slurry 230 generally occurs when the de-aerated frosting slurry 230 is at a temperature range of about 105° F. to about 140° F. As an example, homogenization can be conducted when the de-aerated frosting slurry 230 is at a temperature range of about 130° F. to about 140° F. In another embodiment, homogenization can be conducted when the de-aerated frosting slurry 230 is at a temperature range of about 105° F. to about 125° F., and preferably about 109° F. to about 121° F.

It is generally believed that when the de-aerated frosting slurry 230 is at a temperature range of 105° F. to 140° F., the fat molecules are present in the de-aerated frosting slurry 230 in liquid form which helps the homogenization process. Preferably, the density of the homogenized frosting slurry ranges from about 1.15 g per mL to about 1.25 g per mL after homogenization.

After de-aeration or optional homogenization, the frosting slurry 230 is transferred into a cooling apparatus 236 and cooled down to a temperature ranging from about 70° F. to about 95° F. After cooling, the cooled frosting slurry 238 is transferred from the cooling apparatus 236 and into an aerating apparatus 240 where an inert gas 242 is added to the cooled frosting slurry 238. After adding, the inert gas 242, the frosting composition is whipped in the aerating apparatus 240 with concomitant cooling to form a low density whipped frosting composition 244 having a density of about 0.65 g per mL to about 0.95 g per mL. After whipping, the whipped frosting composition 244 is transferred from the aerating apparatus into a packaging apparatus that packages the whipped frosting composition 244 to form a packaged frosting composition.

The present invention is more particularly described in the following examples that are intended as illustrations only since numerous modifications and variations within the scope of the present invention will be apparent to those skilled in the art.

### EXAMPLES

### Example 1

This example illustrates a method for producing about 300 pounds of a low density vanilla whipped frosting. Initially, an emulsifier composition was formed by thoroughly mixing about 0.35 weight percent of Texture Lite®, about 0.05 weight percent lecithin, about 0.10 weight percent Polysorbate 80, about 8.85 weight percent high maltose corn syrup, about 16.76 weight percent water, about 0.25 weight percent vanilla flavor, about 0.20 weight percent titanium dioxide, about 0.15 weight percent salt, about 0.10 weight percent sodium acid pyrophosphate, about 0.16 weight percent potassium sorbate, about 0.08 weight percent citric acid, about 1 weight percent non-fat dry milk, about 0.40 weight percent of Cellulose Gel® and about 0.20 weight percent of carrageenan gum while heating.

Next, when the emulsifier composition reached a temperature of about 120° F. and about 51.11 weight percent ground sucrose were added to the emulsifier composition to form an aqueous sugar composition. The aqueous sugar composition was continuously mixed while heating until a temperature of about 150° F. was attained so that both the corn syrup and the ground sucrose reached maximum solubility. Upon reaching the temperature of about 150° F., the aqueous sugar composition was mixed for an additional five minutes while maintaining the temperature of about 150° F.

Next, about 20.14 weight percent of a shortening blend containing 95 weight percent partially hydrogenated soybean oil and 5 weight percent partially hydrogenated cottonseed oil having an iodine value of about 72 to about 78 that had been melted at a temperature of about 145° F. to remove all traces of fat crystalline material was added to the aqueous sugar composition. The shortening component and the aqueous sugar composition were mixed while maintaining the temperature of about 150° F. until a smooth frosting slurry was attained. The density of the smooth frosting slurry was about 1.14 grams per mL.

After forming the smooth frosting slurry, the frosting slurry was transported into a vacuum apparatus where any gases that were entrapped in the smooth frosting slurry were removed to form a de-aerated frosting slurry. The vacuum apparatus was operated under about 21 inches of vacuum pressure and the temperature of the frosting slurry ranged from about 140° F. to about 150° F. during de-aeration. The density of the de-aerated frosting slurry was about 1.18 grams per mL.

The de-aerated frosting slurry was transferred into a homogenizer to reduce the diameter of the fat molecules down to very small uniform-sized pieces and form a homogenized frosting slurry. Homogenization was accomplished using a two-stage piston homogenizer that operated at about 500 to about 1000 psi at the first stage and about 500 psi at the second stage. In addition, homogenization of the de-aerated frosting slurry generally occurred when the de-aerated frosting slurry was at a temperature of about 130° F. to about 140° F. The density of the homogenized frosting slurry was about 1.18 grams per mL.

After homogenizing, the homogenized frosting slurry was cooled from a temperature of about 140° F. to a temperature of about 74° F. to enhance gas retention in the final whipped white frosting. Cooling was conducted by using scraped surface heat exchangers, The total cooling time was about 110 seconds and the density of the cooled homogenized frosting slurry was about 1.19 grams per mL. After cooling, about 115 mL to about 150 mL of nitrogen gas per pound of nitrogen gas was added to the homogenized frosting slurry having a temperature of about 75° F. The frosting slurry was sheared using a single aeration head operated at about 225 to about 600 rpm for about 9 seconds to about 18 seconds until a density of about 0.78 grams per mL was reached in the frosting after shearing. Aeration occurred with simultaneous cooling so that maximum gas incorporation was attained. After aeration, the white frosting was sent to a packaging system where the frosting was packaged into the appropriate packaging material.

### Example 2

This example illustrates a method for producing about 300 pounds of a low density chocolate whipped frosting. Initially, an emulsifier composition was formed by thoroughly mixing about 17.58 weight percent water, about 0.80 weight percent of Texture Lite®, about 0.10 weight percent lecithin, about 0.10 weight percent Polysorbate 80, about 12.10 weight percent high maltose corn syrup, about 0.40 weight percent vanilla flavor, about 0.05 weight percent titanium dioxide, about 0.40 weight percent salt, about 0.10 weight percent sodium acid pyrophosphate, about 0.16 weight percent potassium sorbate, about 0.08 weight percent citric acid, about 0.40 weight percent of Cellulose Gel®, about 0.20 weight percent of carrageenan gum while heating.

Next, when the emulsifier composition reached a temperature of about 120° F., about 5 weight percent chocolate liquor and about 40.45 weight percent ground sucrose were added to the emulsifier composition to form an aqueous sugar composition. The aqueous sugar composition was continuously mixed while heating until a temperature of about 150° F. was attained so that both the corn syrup and the ground sucrose reached maximum solubility. Upon reaching the temperature of about 150° F., the aqueous sugar composition was mixed for an additional five minutes while maintaining the temperature of about 150° F.

Next, about 20.08 weight percent of a shortening blend containing 95 weight percent partially hydrogenated soybean oil and 5 weight percent partially hydrogenated cottonseed oil having an iodine value of about 72 to about 78 that had been melted at a temperature of about 145° F. to remove all traces of fat crystalline material was added to the aqueous sugar composition. After adding the shortening component, about 2 weight percent cocoa powder was added. The cocoa powder, shortening component and the aqueous sugar composition were mixed while maintaining the temperature of about 150° F. until a smooth frosting slurry was attained. The density of the smooth frosting slurry was about 1.16 grams per mL.

After forming the smooth frosting slurry, the frosting slurry was transported into a vacuum apparatus where any gases that were entrapped in the smooth frosting slurry were removed to form a de-aerated frosting slurry. The vacuum apparatus was operated under about 21 inches of vacuum pressure and the temperature of the frosting slurry ranged from about 140° F. to about 150° F. during de-aeration.

The de-aerated frosting slurry was transferred into a homogenizer to reduce the diameter of the fat molecules down to very small uniform-sized pieces and form a homogenized frosting slurry. Homogenization was accomplished using a two-stage piston homogenizer that operated at about 500 to about 1000 psi at the first stage and about 500 psi at the second stage. In addition, homogenization of the de-aerated frosting slurry generally occurred when the de-aerated frosting slurry was at a temperature of about 130° F. to about 140° F. The density of the homogenized frosting slurry was about 1.18 grams per mL.

After homogenizing, the homogenized frosting slurry was cooled from a temperature range of about 140° F. to a temperature of about 74° F. to enhance gas retention in the final whipped chocolate frosting product. Cooling was accomplished by using scraped surface heat exchangers. The total cooling time was about 110 seconds, and the density of the cooled homogenized frosting slurry was about 118 grams per mL.

After cooling, about 115 mL to about 150 mL of nitrogen gas per pound of slurry was injected into the homogenized frosting slurry having a temperature of about 74° F. The frosting slurry was whipped using a single aeration head operated at about 225 to about 600 rpm for about 9 seconds to about 18 seconds until a density of about 0.78 grams per mL was reached in the frosting after whipping. Aeration was conducted with simultaneous cooling so that maximum gas incorporation was attained. After aeration, the whipped chocolate frosting was sent to a packaging system where the frosting was packaged into the appropriate packaging material.

### Example 3

This example illustrates a method for producing about 450 to about 6000 pounds of a vanilla whipped frosting. Initially, about 16.86 weight percent purified water was added to a mix kettle and heated to a temperature of about 119° F. to about 131° F. Next, about 8.98 weight percent high maltose corn syrup is added to the water and mixed while maintaining the temperature range of about 119° F. to about 131° F. to form a corn syrup-water mixture. After adding the corn syrup, about 0.35 weight percent Texture Lite® the mixture was homogeneously dispersed into the corn-syrup-water mixture to form an emulsifier mixture.

Next, about 0.83 weight percent crystalline fructose, about 0.40 weight percent Cellulose Gel®, and about 0.20 weight percent carrageenan was added to the emulsifier mixture to form a stabilized emulsifier mixture. The stabilized emulsifier mixture was maintained at a temperature of about 119° F. to about 131° F. Next, about 0.50 weight percent flavor, about 0.10 weight percent Polysorbate 80 and about 0.05 weight percent lecithin, about 0.20 weight percent salt, about 0.15 weight percent titanium dioxide, about 0.13 weight percent potassium sorbate, about 0.06 weight percent anhydrous citric acid, and about 0.01 weight percent color were added to the stabilized emulsifier mixture with concomitant heating.

Next, about 50.60 weight percent of a 12× granulated sugar blend that contained about 4 weight percent corn starch was added to the stabilized emulsifier mixture to form an aqueous sugar composition. The aqueous sugar composition was mixed until the sugar blend was completely dispersed.

Next, about 20.57 weight percent of a plastic shortening blend derived from about 93 weight percent partially hydrogenated soybean oil, about 5 weight percent partially hydrogenated cottonseed oil and about 2 weight percent distilled monoglycerides was added to the aqueous sugar composition to form a frosting slurry. The plastic shortening had been melted to remove all traces of fat crystalline material by bringing the temperature of the plastic shortening blend to a temperature range of about 110° F. to about 130° F. The frosting slurry was maintained at a temperature range of about 119° F. to about 131° F. and mixing continued until the melted shortening component was homogeneously dispersed.

The plastic shortening blend had an iodine value of about 75 and a palmitic fatty acid content of about 10.96 weight percent, based on a total fatty acid content of the partially hydrogenated soybean and cottonseed oil blend. The density of the smooth frosting slurry ranged from about 1.00 g per mL to about 1.10 g per mL.

After mixing the smooth frosting slurry, the frosting slurry was transported into a vacuum apparatus where any gases that were entrapped in the smooth frosting slurry were removed to form a de-aerated frosting slurry. The vacuum apparatus was operated under about 21 inches of vacuum pressure and the temperature of the frosting slurry ranged from about 114° F. to about 126° F. during de-aeration. The density of the de-aerated frosting slurry ranged from about 1.15 g per mL to about 1.25 g per mL after de-aeration.

The de-aerated frosting slurry was transferred into a homogenizer to reduce the diameter of the fat molecules down to very small uniform-sized pieces and form a homogenized frosting slurry. Homogenization was accomplished using a two-stage piston homogenizer that operated at about 500 to about 1000 psi at the first stage and about 500 psi at the second stage. In addition, homogenization of the de-aerated frosting slurry generally occurred when the de-aerated frosting slurry was at a temperature of about 109° F. to about 121° F. The density of the homogenized frosting slurry was about 1.15 g per mL to about 1.25 g per mL.

After homogenizing, the homogenized frosting slurry was cooled from a temperature of about 109° F. to 121° F. to a temperature of about 77° F. to about 83° F. to enhance gas retention in the vanilla whipped frosting. Cooling was conducted by using scraped surface heat exchangers. The total cooling time was about 120 seconds and the density of the cooled homogenized frosting slurry was about 1.15 g per mL to about 1.25 g per mL.

After cooling, about 115 mL to about 150 mL of nitrogen gas per pound of slurry was added to the homogenized frosting slurry having a temperature of about 77° F. to about 83° F. The frosting slurry was whipped using one aeration head and operated at about 400 rpm for about 9 seconds to about 18 seconds until a density of about 0.75 g per mL to about 0.81 g per mL was reached in the frosting after whipping. Whipping slightly increased the temperature of the frosting to a range of about 84° F. to about 90° F. although aeration was performed with simultaneous cooling to maximize gas incorporation. After aeration, the vanilla whipped frosting was sent to a packaging system where the vanilla whipped frosting was packaged into the appropriate packaging material.

### Example 4

This example illustrates a method for producing about 450 to about 6000 pounds of a chocolate whipped frosting. Initially, about 17.81 weight percent purified water was added to a mix kettle and heated to a temperature of about 119° F. to about 131° F. Next, about 2.76 weight percent high maltose corn syrup is added to the water and mixed while maintaining the temperature range of about 119° F. to about 131° F. to form a corn syrup-water mixture. After adding the corn syrup, about 0.35 weight percent Texture Lite® was homogeneously dispersed into the corn-syrup-water mixture to form an emulsifier mixture.

Next, about 3.33 weight percent crystalline fructose, about 0.40 weight percent Cellulose Gel®, and about 0.20 weight percent carrageenan was added to the emulsifier mixture to form a stabilized emulsifier mixture. The stabilized emulsifier mixture was maintained at a temperature of about 119° F. to about 131° F. Next, about 0.35 weight percent flavor, about 0.10 weight percent Polysorbate 80 and about 0.05 weight percent lecithin, about 0.40 weight percent salt, about 0.13 weight percent potassium sorbate, about 0.14 weight percent anhydrous citric acid, about 5 weight percent cocoa, and about 0.01 weight percent color was added to the stabilized emulsifier mixture with concomitant heating.

Next, about 52.20 weight percent of a 12× granulated sugar blend that contained about 4 weight percent corn starch was added to the stabilized emulsifier mixture to form an aqueous sugar composition. The aqueous sugar composition was mixed until the sugar blend was completely dispersed.

Next, about 16.78 weight percent of a plastic shortening blend derived from about 93 weight percent partially hydrogenated soybean oil, about 5 weight percent partially hydrogenated cottonseed oil and about 2 weight percent distilled monoglycerides was added to the aqueous sugar composition to form a frosting slurry. The plastic shortening blend had been melted to remove all traces of fat crystalline material by bringing the temperature of the plastic shortening blend to a temperature range of about 110° F. to about 130° F. The frosting slurry was maintained at a temperature range of about 119° F. to about 131° F. and mixing continued until the melted shortening blend was homogeneously dispersed.

The plastic shortening blend had an iodine value of about 75 and a palmitic fatty acid content of about 10.96 weight percent, based on a total fatty acid content of the plastic shortening blend. The density of the smooth frosting slurry ranged from about 1.00 g per mL to about 1.10 g per mL.

After mixing, the frosting slurry was transported into a vacuum apparatus where any gases that were entrapped in the smooth frosting slurry were removed to form a de-aerated frosting slurry. The vacuum apparatus was operated under about 21 inches of vacuum pressure and the temperature of the frosting slurry ranged from about 114° F. to about 126° F. during de-aeration. The density of the de-aerated frosting slurry ranged from about 1.15 g per mL to about 1.25 g per mL after de-aeration.

The de-aerated frosting slurry was transferred into a homogenizer to reduce the diameter of the fat molecules down to very small uniform-sized pieces and form a homogenized frosting slurry. Homogenization was accomplished using a two-stage piston homogenizer that operated at about 500 to about 1000 psi at the first stage and about 500 psi at the second stage. In addition, homogenization of the de-aerated frosting slurry generally occurred when the de-aerated frosting slurry was at a temperature of about 109° F. to about 121° F. The density of the homogenized frosting slurry was about 1.15 g per mL, to about 1.25 g per mL.

After homogenizing, the homogenized frosting slurry was cooled from a temperature of about 109° F. to 121° F. to a temperature of about 87° F. to about 93° F. to enhance gas retention in the chocolate whipped frosting. Cooling was conducted by using scraped surface heat exchangers. The total cooling time was about 120 seconds and the density of the cooled homogenized frosting slurry was about 1.15 g per mL to about 1.25 g per mL.

After cooling, about 115 mL to about 150 mL nitrogen gas per pound of slurry was added to the homogenized frosting slurry having a temperature of about 87° F. to about 93° F. The frosting slurry was sheared using one aeration head and operated at about 400 rpm for about 9 seconds to about 18 seconds until a density of about 0.75 g per mL to about 0.81 g per mL was reached in the frosting. Shearing slightly increased the temperature of the frosting to a range of about 92° F. to about 98° F. although aeration was performed with simultaneous cooling to maximize gas incorporation. After aeration and shearing, the chocolate whipped frosting was sent to a packaging system where the chocolate whipped frosting was packaged into the appropriate packaging material.

### Example 5

This example illustrates a method for producing about 450 to about 6000 pounds of a cream cheese flavored whipped frosting. Initially, about 16.87 weight percent purified water was added to a mix kettle and heated to a temperature of about 119° F. to about 131° F. Next, about 8.98 weight percent high maltose corn syrup is added to the water and mixed while maintaining the temperature range of about 119° F. to about 131° F. to form a corn syrup-water mixture. After adding the corn syrup, about 0.35 weight percent Texture Lite® was homogeneously dispersed into the corn-syrup-water mixture to form an emulsifier mixture.

Next, about 0.83 weight percent crystalline fructose, about 0.40 weight percent Cellulose Gel®, and about 0.20 weight percent carrageenan was added to the emulsifier mixture to form a stabilized emulsifier mixture. The stabilized emulsifier mixture was maintained at a temperature of about 119° F. to about 131° F. Next, about 0.35 weight percent flavor, about 0.10 weight percent Polysorbate 80 and about 0.05 weight percent lecithin, about 0.20 weight percent salt, about 0.15 weight percent titanium dioxide, about 0.13 weight percent potassium sorbate, about 0.06 weight percent anhydrous citric acid, and about 0.05 weight percent color was added to the stabilized emulsifier mixture with concomitant heating.

Next, about 50.72 weight percent of a 12× granulated sugar blend that contained about 4 weight percent corn starch was added to the stabilized emulsifier mixture to form an aqueous sugar composition. The aqueous sugar composition was mixed until the sugar was completely dispersed.

Next, about 20.57 weight percent of a plastic shortening blend derived from about 93 weight percent partially hydrogenated soybean oil, about 5 weight percent partially hydrogenated cottonseed oil, and about 2 weight percent distilled monoglycerides was added to the aqueous sugar composition to form a frosting slurry. The plastic shortening had been melted to remove all traces of fat crystalline material by bringing the temperature of the plastic shortening blend to a temperature range of about 110° F. to about 130° F. The frosting slurry was maintained at a temperature range of about 119° F. to about 131° F. and mixing continued until the melted shortening blend was homogeneously dispersed.

The plastic shortening blend had an iodine value of about 75 and a palmitic fatty acid content of about 10.96 weight percent, based on a total fatty acid content of the plastic shortening blend. The density of the smooth frosting slurry ranged from about 1.00 g per mL to about 1.10 g per mL.

After mixing, the frosting slurry was transported into a vacuum apparatus where any gases that were entrapped in the smooth frosting slurry were removed to form a de-aerated frosting slurry. The vacuum apparatus was operated under about 21 inches of vacuum and the temperature of the frosting slurry ranged from about 114° F. to about 126° F. during de-aeration. The density of the de-aerated frosting slurry ranged from about 1.15 g per mL to about 1.25 g per mL after de-aeration.

The de-aerated frosting slurry was transferred into a homogenizer to reduce the diameter of the fat molecules down to very small uniform-sized pieces and form a homogenized frosting slurry. Homogenization was accomplished using a two-stage piston homogenizer that operated at about 500 to about 1000 psi at the first stage and about 500 psi at the second stage. In addition, homogenization of the de-aerated frosting slurry generally occurred when the de-aerated frosting slurry was at a temperature of about 109° F. to about 121° F. The density of the homogenized frosting slurry was about 1.15 g per mL to about 1.25 g per mL.

After homogenizing, the homogenized frosting slurry was cooled from a temperature of about 109° F. to 121° F. to a temperature of about 77° F. to about 83° F. to enhance gas retention in the cream cheese flavored whipped frosting. Cooling was conducted by using scraped surface heat exchangers. The total cooling time was about 120 seconds and the density of the cooled homogenized frosting slurry was about 1.15 g per mL to about 1.25 g per mL.

After cooling, about 115 mL to about 150 mL of nitrogen gas per pound of slurry was injected into the homogenized frosting slurry having a temperature of about 77° F. to about 83° F. The frosting slurry was sheared using two aeration heads placed in series with each other and operated at about 150 rpm for about 14 seconds to about 16 seconds until a density of about 0.75 g per mL to about 0.81 g per mL was reached in the frosting. Shearing increased the temperature slightly to a range of about 84° F. to about 90° F. even though aeration was performed with simultaneous cooling to maximize gas incorporation. After aeration and shearing, the cream cheese flavored whipped frosting was sent to a packaging system where the cream cheese flavored whipped frosting was packaged into the appropriate packaging material.

### Example 6

This example illustrates the effect of varying the concentration of stabilizers, the concentration of emulsifiers, aeration conditions and the inclusions or absence of a homogenization step on producing a stable low density whipped frosting. A cream cheese flavored whipped frosting was prepared according to Example 5 except the whipped frosting was cooled to approximately 80° F. The levels of treatments/components were designed to bracket the optimal ranges of each treatment and are presented below:

### 1. Emulsifiers

a. Low Level: Texture Lite @ 0.1 wt %, Polysorbate 80 @ 0.05 wt %
b. High Level: Texture Lite @ 0.7 wt %, Polysorbate 80 @ 0.25 wt %
c. Lecithin and mono- and di-glycerides in the shortening were kept constant.

### 2. Stabilizers

a. Low Level: Cellulose Gel @ 0.1 wt %, Carrageenan @ 0.05 wt %
b. High Level: Cellulose Gel @ 0.8 wt %, Carrageenan @ 0.4 wt %

### 3. RPMs During Whipping/Aeration

a. Low Level: 100 RPMs
b. High Level: 400 RPMs

### 4. Homogenizer

a. Low Level: Off and Bypassed
b. High Level: In line and running @ 1000 psi
   The experimental design that was followed is presented below:

| | Batch 1 | | | | Batch 2 | | | |
|---|---|---|---|---|---|---|---|---|
| Trial# | 1A | 1B | 1C | 1D | 2A | 2B | 2C | 2D |
| Gums | Low | Low | Low | Low | High | High | High | High |
| Emulsifiers | Low | Low | Low | Low | Low | Low | Low | Low |
| RPMs | 100 | 400 | 100 | 400 | 100 | 400 | 100 | 400 |
| Homogenizer | On | On | Off | Off | On | On | Off | Off |
| | Batch 3 | | | | Batch 4 | | | |
| Trial# | 3A | 3B | 3C | 3D | 4A | 4B | 4C | 4D |
| Gums | Low | Low | Low | Low | High | High | High | High |
| Emulsifiers | High | High | High | High | High | High | High | High |
| RPMs | 100 | 400 | 100 | 400 | 100 | 400 | 100 | 400 |
| Homogenizer | On | On | Off | Off | On | On | Off | Off |

Twelve samples were taken from each run and analyzed at time zero for density and at 48 hrs and 7 days for change in untouched density and stirred density. Bubble size analysis and thermal abuse were also performed after a 48 hour time period. The results are presented in Table 2 below:

TABLE 2

| | | | | | 48-hr | 7-Day | |
|---|---|---|---|---|---|---|---|
| | Thermal | | 48 hr | 7-Day | change in | change in | |
| | abuse | Initial | change in | change in | density | density | Bubble SD |
| Trial | Failure | density | density | density | Stirred | Stirred | μm |
| 1A | Y | 1.01 | 0.04 | 0.03 | 0.1 | 0.1 | 2.22 |
| 1B | Y | 0.83 | 0.08 | 0.08 | 0.2 | 0.22 | 2.66 |
| 1C | Y | 1.01 | 0.08 | 0.04 | 0.1 | 0.12 | 2.98 |
| 1D | Y | 0.84 | 0.09 | 0.07 | 0.19 | 0.22 | 3 |
| 2A | N | 0.97 | 0.06 | 0.08 | 0.12 | 0.13 | 14.45 |
| 2B | N | 0.78 | 0.13 | 0.16 | 0.2 | 0.21 | 12.05 |
| 2C | N | 0.92 | 0.08 | 0.11 | 0.15 | 0.17 | 14.19 |
| 2D | N | 0.77 | 0.15 | 0.17 | 0.2 | 0.22 | 18.37 |
| 3A | Y | 0.87 | 0.04 | 0.07 | 0.1 | 0.14 | 8.79 |
| 3B | Y | 0.77 | 0.01 | 0.03 | 0.11 | 0.15 | 11.85 |
| 3C | Y | 0.87 | 0.01 | 0.02 | 0.11 | 0.16 | 11.51 |
| 3D | Y | 0.79 | −0.01 | 0.04 | 0.13 | 0.19 | 9.61 |
| 4A | N | 0.85 | 0.06 | 0.1 | 0.12 | 0.13 | 12.13 |
| 4B | N | 0.78 | 0.07 | 0.07 | 0.12 | 0.12 | 12.33 |
| 4C | N | 0.85 | 0.09 | 0.1 | 0.16 | 0.15 | 13.31 |
| 4D | N | 0.77 | 0.04 | 0.09 | 0.13 | 0.17 | 15.74 |

The results of the experiment are as follows:

1. An increase in stabilizers:
a. Has a positive effect on thermal stability and the whipped frosting becomes more stable when subjected to high temperature cycling
b. Has a negative effect on bubble size and the gas bubbles become larger and have a greater size distribution
c. Has a negative effect on changes in density over time, and the whipped frosting density increasing to a greater extent over time
   Increasing the concentration of emulsifiers:
a. Has no effect on thermal stability
b. Has a negative effect on bubble size with the gas bubbles becoming larger and have a greater size distribution
c. Has a positive effect on changes in density over time, with the whipped frosting density increasing to a lesser extent over time
   Increasing the RPM's during aeration:
a. Has no effect on thermal stability
b. Has a slightly negative effect on changes in density over time
c. Has a greatly positive effect on how low in density the frosting can be whipped, and whether target density can be reached
   Use of the homogenizer had little or no effect on the change in density or stirred density, air cell (bubble) size deviation and thermal stability.

Although the present invention has been described with reference to preferred embodiments, workers skilled in the art will recognize that changes may be made in form and detail without departing from the spirit and scope of the invention.

1-12. (canceled)

13. A whipped frosting having a stable density of from about 0.65 grams per mL to about 0.95 grams per mL comprising a dispersion of inert gas-filled cells retained within a frosting composition,
wherein the frosting composition consists essentially of:
a. a sweetening component composed of one or more sweetening agents;
b. a plastic shortening component composed of one or more shortening blends;
c. a liquid component selected from the group consisting of water, a liquid component associated with the sweetening component, and combinations thereof;
d. from about 0.30 weight percent to about 1.35 weight percent of the total weight of the frosting composition of an emulsifying component composed of one or more emulsifying agents, wherein at least one emulsifying agent is an aerating emulsifying agent; and
e. from about 0.15 weight percent to about 1.20 weight percent of the total weight of the frosting composition of a stabilizing component composed of one or more stabilizing agents, and
wherein the emulsifying component and the stabilizing component form a three dimensional matrix for retaining the dispersion of inert gas-filled cells within the frosting composition to thereby stabilize the density of the whipped frosting.

14. The whipped frosting of claim 13 wherein the whipped frosting exhibits thermal stability.

15. The whipped frosting of claim 14 wherein the thermally stability is measured by a lack of visible phase separation of the aqueous, oil, and solid phases of the whipped frosting after the whipped frosting is cycled from a temperature of about 70° F. to about 130° F. six times within a span of about 18 minutes.

16. The whipped frosting of claim 13 wherein the density of the whipped frosting increases by no more than about 11% after about 48 hours.

17. The whipped frosting of claim 13 wherein the density of the whipped frosting increases by no more than about 12% after about seven days.

18. The whipped frosting of claim 13 wherein the inert gas-filled cells are uniformly dispersed within the frosting composition.

19. The whipped frosting of claim 13 wherein the inert gas-filled cells have a cell size distribution of from about 12 microns to about 16 microns.

20. The whipped frosting of claim 13 wherein the inert gas is selected from the group consisting of air, nitrogen, nitrous oxide, carbon dioxide, and combinations thereof.

21. The whipped frosting of claim 13 wherein the one or more sweetening agents are selected from the group consisting of sucrose, fructose, dextrose, maltose, lactose, galactose, sorbitol, cane sugar, beet sugar, corn syrup, honey, molasses, invert sugar, high maltose corn syrup, high fructose corn syrup, and combinations thereof.

22. The whipped frosting of claim 13 wherein the one or more shortening blends are selected from the group consisting of a non-hydrogenated fat blend, a fractionated fat blend, a partially hydrogenated fat blend, a hydrogenated fat blend, a fully hydrogenated fat blend, an interesterified fat blend, and combinations thereof.

23. The whipped frosting of claim 13 wherein the plastic shortening component has a palmitic fatty acid content of less than about 13 weight percent based on a total fatty acid content of the plastic shortening component.

24. The whipped frosting of claim 23 wherein the plastic shortening component has a palmitic fatty acid component of less than about 11.5 weight percent based on a total fatty acid content of the plastic shortening component.

25. The whipped frosting of claim 24 wherein the plastic shortening component does not contain a palm oil hardstock.

26. The whipped frosting of claim 13 wherein the emulsifying component is composed of:
a. one or more aerating emulsifying agents selected from the group consisting of esters of polyhydric alcohols, polyoxyethylene sorbitan monostearate, polyglycerol esters of higher fatty acids, polyoxy-20-ethylene sorbitan monooleate, polyoxy-20-ethylene sorbitan stearate, and combinations thereof; and
b. one or more emulsifying agents selected from the group consisting of monoglycerides, diglycerides, propylene glycol monosterate, polypropylene esters of fatty acid, sodium stearoyl lactylate, lecithin, triglycerol monostearate, decaglycerol monooleate, decaglycerol monopalmitate, decagylcerol dipalmitate, hexaglycerol monostearate, and combinations thereof.

27. The whipped frosting of claim 13 wherein the aerating emulsifying agent consists essentially of a blend of distilled monoglycerides, distilled propylene glycol, and sodium steroyl lactylate.

28. The whipped frosting of claim 13 wherein the one or more stabilizing agents are selected from the group consisting of microcrystalline cellulose, sodium carboxymethylcellulose, carboxyrnethylcellulose, xanthan gum, whey protein isolate, whey protein concentrate, milk protein concentrate, milk protein isolate, whey, whey powder, whey protein, skim milk, nonfat dry milk, milk powder, casein, caseinates, milk protein, whey hydrolysate, buttermilk, whole milk, high fat milk powder, carrageenan, alginate, and combinations thereof.

29. The whipped frosting of claim 13 having a stable density from about 0.65 grams per mL to about 0.80 grams per mL.

30. A whipped frosting having a stable density of from about 0.65 grams per mL to about 0.95 grams per mL comprising a dispersion of inert gas-filled cells retained within a frosting composition,
wherein the frosting composition consists essentially of:
a. from about 35 weight percent to about 76 weight percent of the total weight of the frosting composition of a sweetening component composed of one or more sweetening agents;
b. from about 12 weight percent to about 30 weight percent of the total weight percent of the frosting composition of a plastic shortening component composed of one or more shortening blends;
c. from about 10 weight percent to about 25 weight percent of the total weight percent of the frosting composition of a liquid component selected from the group consisting of water, a liquid component associated with the sweetening component, and mixtures thereof;
d. from about 0.30 weight percent to about 1.35 weight percent of the total weight of the frosting composition of an emulsifying component composed of one or more emulsifying agents, wherein at least one emulsifying agent is an aerating emulsifying agent; and
e. from about 0.15 weight percent to about 1.20 weight percent of the total weight of the frosting composition of a stabilizing component composed of one or more stabilizing agents, and
wherein the emulsifying component and the stabilizing component form a three dimensional matrix for retaining the dispersion of inert gas-filled cells within the frosting composition to thereby stabilize the density of the whipped frosting.

31. The whipped frosting of claim 30 wherein the from about 35 weight percent to about 76 weight percent of the total weight of the frosting composition of a sweetening component further comprises from about 51 weight percent to about 76 weight percent of the total weight of the frosting composition.

32. The whipped frosting of claim 30 wherein the from about 30 weight percent to about 76 weight percent of the total weight of the frosting composition of a sweetening component further comprises from about 42 weight percent to about 76 weight percent of the total weight of the frosting composition.

33. The whipped frosting of claim 32 wherein the from about 42 weight percent to about 76 weight percent of the total weight of the frosting composition of a sweetening component further comprises from about 42 weight percent to about 71 weight percent of the total weight of the frosting composition.

34. The whipped frosting of claim 30 wherein the from about 12 weight percent to about 30 weight percent of the total weight percent of the frosting composition of a plastic shortening component further comprises from about 16 weight percent to about 21 weight percent of the total weight of the frosting composition.

35. The whipped frosting of claim 30 wherein the from about 10 weight percent to about 25 weight percent of the total weight percent of the frosting composition of a liquid component further comprises from about 15 weight percent to about 21 weight percent of the total weight of the frosting composition.

36. The whipped frosting of claim 30 wherein the from about 10 weight percent to about 25 weight percent of the total weight percent of the frosting composition of a liquid component further comprises from about 12 weight percent to about 21 weight percent of the total weight of the frosting composition.

37. The whipped frosting of claim 36 wherein the from about 12 weight percent to about 21 weight percent of the total weight percent of the frosting composition of a liquid component further comprises from about 12 weight percent to about 18 weight percent of the total weight of the frosting composition.

38. The whipped frosting of claim 30 wherein the inert gas is selected from the group consisting of air, nitrogen, nitrous oxide, carbon dioxide, and combinations thereof.

39. The whipped frosting of claim 30 wherein the one or more sweetening agents are selected from the group consisting of sucrose, fructose, dextrose, maltose, lactose, galactose, sorbitol, cane sugar, beet sugar, corn syrup, honey, molasses, invert sugar, high maltose corn syrup, high fructose corn syrup, and combinations thereof.

40. The whipped frosting of claim 30 wherein the one or more shortening blends are selected from the group consisting of a non-hydrogenated fat blend, a fractionated fat blend, a partially hydrogenated fat blend, a hydrogenated fat blend, a fully hydrogenated fat blend, an interesterified fat blend, and combinations thereof.

41. The whipped frosting of claim 30 wherein the plastic shortening component has a palmitic fatty acid content of less than about 13 weight percent based on a total fatty acid content of the plastic shortening component.

42. The whipped frosting of claim 41 wherein the plastic shortening component has a palmitic fatty acid component of less than about 11.5 weight percent based on a total fatty acid content of the plastic shortening component.

43. The whipped frosting of claim 42 wherein the plastic shortening component does not contain a palm oil hardstock.

44. The whipped frosting of claim 30 wherein the emulsifying component is composed of:
a. one or more aerating emulsifying agents selected from the group consisting of esters of polyhydric alcohols, polyoxyethylene sorbitan monostearate, polyglycerol esters of higher fatty acids, polyoxy-20-ethylene sorbitan monooleate, polyoxy-20-ethylene sorbitan stearate, and combinations thereof; and
b. one or more emulsifying agents selected from the group consisting of monoglycerides, diglycerides, propylene glycol monosterate, polypropylene esters of fatty acid, sodium stearoyl lactylate, lecithin, triglycerol monostearate, decaglycerol monooleate, decaglycerol monopalmitate, decagylcerol dipalmitate, hexaglycerol monostearate, and combinations thereof.

45. The whipped frosting of claim 30 wherein the aerating emulsifying agent consists essentially of a blend of distilled monoglycerides, distilled propylene glycol, and sodium steroyl lactylate.

46. The whipped frosting of claim 30 wherein the one or more stabilizing agents are selected from the group consisting of microcrystalline cellulose, sodium carboxymethylcellulose, carboxyrnethylcellulose, xanthan gum, whey protein isolate, whey protein concentrate, milk protein concentrate, milk protein isolate, whey, whey powder, whey protein, skim milk, nonfat dry milk, milk powder, casein, caseinates, milk protein, whey hydrolysate, buttermilk, whole milk, high fat milk powder, carrageenan, alginate, and combinations thereof.

47. The whipped frosting of claim 30 having a stable density from about 0.65 grams per 1 mL to about 0.80 grams per mL.

48. A whipped frosting having a stable density of from about 0.65 grams per mL to about 0.95 grams per mL comprising a dispersion of inert gas-filled cells retained within a frosting composition,
wherein the frosting composition is essentially free of inulin and maltodextrin and comprises:
a. a sweetening component comprising one or more sweetening agents;
b. a plastic shortening component comprising one or more shortening blends;
c. a liquid component selected from the group consisting of water, a liquid component associated with the sweetening component, and mixtures thereof;
d. from about 0.30 weight percent to about 1.35 weight percent of the total weight of the frosting composition of an emulsifying component comprising one or more emulsifying agents, wherein at least one emulsifying agent is an aerating emulsifying agent; and
e. from about 0.15 weight percent to about 1.20 weight percent of the total weight of the frosting composition of a stabilizing component comprising one or more stabilizing agents, and
wherein the emulsifying component and the stabilizing component form a three dimensional matrix for retaining the dispersion of inert gas-filled cells within the frosting composition to thereby stabilize the density of the whipped frosting.

49. The whipped frosting of claim 48 wherein the whipped frosting exhibits a thermal stability measured by a lack of visible phase separation of the aqueous, oil, and solid phases of the whipped frosting after the whipped frosting is cycled from a temperature of about 70° F. to about 130° F. six times within a span of about 18 minutes.

50. The whipped frosting of claim 48 wherein the density of the whipped frosting increases by no more than about 11% after about 48 hours and increases by no more than about 12% after about seven days.

51. The whipped frosting of claim 48 wherein the inert gas-filled cells are uniformly dispersed within the frosting composition and have a cell size distribution of from about 12 microns to about 16 microns.

52. The whipped frosting of claim 48 wherein
a. the sweetening component further comprises from about 35 weight percent to about 76 weight percent of the total weight of the frosting composition;
b. the plastic shortening component further comprises from about 12 weight percent to about 30 weight percent of the total weight percent of the frosting composition; and
c. the liquid component further comprises from about 10 weight percent to about 25 weight percent of the total weight percent of the frosting composition.
